(19) United States
(12) Patent Application Publication
(10) Pub. No.: US 2008/0152404 A1
(43) Pub. Date: Jun. 26, 2008

(54) Fixing device and image forming apparatus

(75) Inventors: Daisuke Yoshino, Kanagawa (JP); Toshiyuki Miyata, Kanagawa (JP); Yasuhiro Uehara, Kanagawa (JP); Yasuo Sakaguchi, Kanagawa (JP); Hitoshi Okazaki, Kanagawa (JP); Takuro Hoshio, Kanagawa (JP); Fumio Daishi, Kanagawa (JP)

Correspondence Address: MORGAN LEWIS & BOCKIUS LLP, 1111 PENNSYLVANIA AVENUE NW, WASHINGTON, DC, 20004, US

(73) Assignee: Fuji Xerox Co.,Ltd.

(21) Appl. No.: 11/819,108

(22) Filed: Jun. 25, 2007

(30) Foreign Application Priority Data
Dec. 21, 2006 (JP) P2006-344311

(51) Int. Cl. G03G 15/20

(52) U.S. Cl. 399/329; 399/333

(57) ABSTRACT

A fixing device comprises: a fixing belt that has a surface release layer of a fluorinated-resin tube, the fixing belt being laid across by a fixing roller and a tension roller; a pressurizing member that presses the fixing roller through the fixing belt; and a release member that presses the fixing belt on the pressurizing member, in a substantial vicinity of a downstream of a pressure contact site of between the fixing roller and the pressurizing member, and strips a recording material from the fixing belt, the fixing device fixing a toner image on the recording material by heat.

### CROSS-REFERENCE TO RELATED APPLICATIONS

This application is based on and claims priority under 35 USC 119 from Japanese Patent Application No. 2006-344311 filed Dec. 21, 2006.

### BACKGROUND

(i) Technical Field

The present invention relates to fixing devices or the like and more particularly to a fixing device or the like for use on an image forming apparatus.

(ii) Related Art

The image forming apparatus, in the conventional, is to form an image by developing the electrostatic latent image, formed on an image-carrying surface, into a toner image, and transferring the toner image onto a recording medium through an intermediate transfer member, followed by fixing it on a recording medium through use of a heater fixing mechanism. As a heater fixing mechanism, there are reported a two-roller scheme that an unfixed toner image is fixed on a recording sheet by passing the recording sheet, transferred with a toner image, through between a heating roller and a pressurizing roller, and a belt-nip scheme that a toner image is fixed on a recording sheet by heating and pressurizing the recording sheet at a nip site of between a fixing belt laid across a plurality of rollers and a pressurizing member.

With the fixing device based on such a heater fixing mechanism, releasability is required at between a fixing member surface and a recording sheet because of the affixing force acting at between the recording sheet and the fixing member caused by the fused toner image at the nip site.

### SUMMARY

According to the invention, there is provided a fixing device that fixes a toner image on a recording material according to a heating scheme, the fixing device comprising: a fixing belt that has a surface release layer of a fluorinated-resin tube, the fixing belt being laid across by a fixing roller and a tension roller; a pressurizing member that presses the fixing roller through the fixing belt; and a release member that presses the fixing belt on the pressurizing member, in a substantial vicinity of a downstream of a pressure contact site of between the fixing roller and the pressurizing member, and strips the recording material from the fixing belt.

### BRIEF DESCRIPTION OF THE DRAWINGS

Exemplary embodiments of the present invention will be described in detail based on the following figure, wherein

FIG. 1 is a schematic construction diagram showing an image forming apparatus according to a present exemplary embodiment;

FIG. 2 is a sectional view showing a schematic structure of a fixing device in the exemplary embodiment;

FIGS. 3A and 3B are figures explaining a relationship between a film-forming process of a surface release layer for a fixing belt and a resulting damage, and a relationship between an elastic layer thickness of a fixing belt and a resulting damage;

FIGS. 4A and 4B are figures explaining a relationship between an elastic layer thickness of a fixing belt and an image quality and a relationship between an on-surface pressure and an image quality;

FIG. 5 is a view explaining a fixing evaluation device; and

FIGS. 6A and 6B are schematic sectional views explaining a deformation in the fixing belt surface.

### DETAILED DESCRIPTION

Now explanation will be made on the exemplary embodiment of the present invention. Note that the invention is not limited to the following exemplary embodiment but can be carried out with various modifications within the scope of the gist thereof. The drawings in use are for explaining the exemplary embodiment but not representative of actual size.

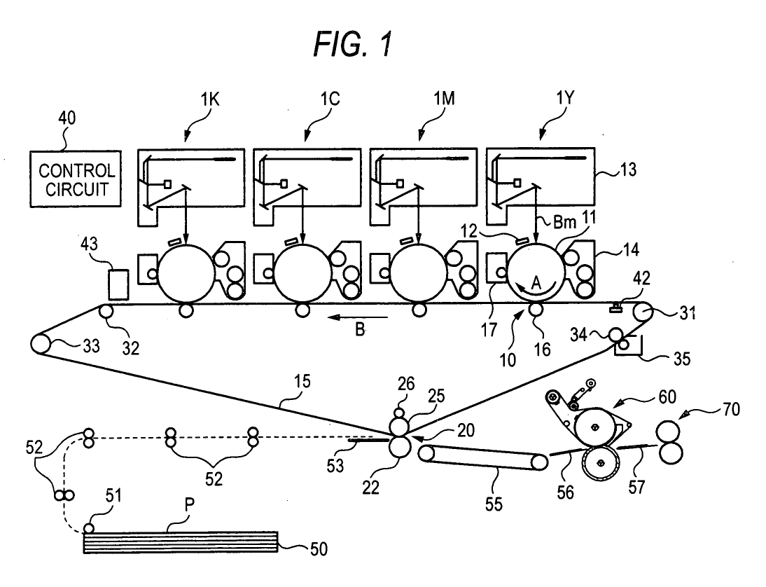

FIG. 1 is a schematic arrangement showing an image forming apparatus to which the present exemplary embodiment is applied. The image forming apparatus, shown in FIG. 1, is of an intermediate transfer scheme generally called the tandem type, which includes a plurality of image forming units 1Y, 1M, 1C, 1K to form toner images in respective color components according to a xerographic scheme, a primary transfer part 10 where to transfer (primarily transfers), in order, the toner images in respective color components formed by the image forming units 1Y, 1M, 1C, 1K onto an intermediate transfer belt 15, a secondary transfer part 20 where to transfer the superposed toner images transferred on the intermediate belt 15 collectively onto a recording sheet P, i.e. recording material (recording paper), a fixing device 60 to fix the secondary-transferred images onto a recording sheet P, and a sheet feed roller 70 serving as a sheet feeder to transport the image-fixed recording sheet P to the downstream. Besides, provided also a control section 40 that controls the operations of the devices (sections).

In the exemplary embodiment, the image forming unit 1Y, 1M, 1C, 1K have a photosensitive drum 11 rotating in a direction of arrow A, around which are arranged xerographic devices, i.e. a charging device 12 that charges the photosensitive drum 11, a laser exposure device 13 that writes an electrostatic latent image onto the photosensitive drum 11 (in the figure, an exposure beam is shown at reference Bm), a development device 14 containing a toner in a color component and visualize the electrostatic latent image of the photosensitive drum 11 through use of the toner, a primary transfer roller 16 that transfers, at a primary transfer part 10, the toner image in a color component formed on the photosensitive drum 11 onto the intermediate transfer belt 15, and a drum cleaner 17 that removes the remaining toner out of the photosensitive drum 11, in the order. Those image forming units 1Y, 1M, 1C, 1K are arranged nearly straight in the order of yellow (Y), magenta (M), cyan (C) and black (K) from the upstream with respect to the intermediate transfer belt 15.

The intermediate transfer belt 15, serving as an intermediate transfer member, is to be circulatively driven (circulated) on various rollers at a predetermined rate in a direction of arrow B shown in FIG. 1. Those various rollers include a drive roller 31 that is to be driven by a motor (not shown) excellent in rotating at a constant rate and to circulate the intermediate transfer belt 15, a support roller 32 that sustains the intermediate transfer belt 15 extending nearly straight along the arrangement direction of the photosensitive drums 11, a tension roller 33 that gives a constant tension to the intermediate transfer belt 15 and serves as a correction roller to prevent the irregular movement of the intermediate transfer belt 15, a backup roller 25 that is provided in the secondary transfer part 20, and a cleaning backup roller 34 that is provided in a cleaning part to scrape the remaining toner out of the intermediate transfer belt 15.

The primary transfer part 10 is made up with a primary transfer roller 16 arranged opposite to the photosensitive drum 11 with respect to the intermediate transfer belt 15. The primary transfer roller 16 is arranged in contact, under pressure, with the photosensitive drum 11 through the intermediate transfer belt 15. Furthermore, the primary transfer roller 16 is to be applied with a voltage (primary transfer bias) in a polarity opposite to the charge polarity (assumed minus in polarity, from now on) of the toner. Due to this, the toner images on the respective photosensitive drums 11 are to be electrostatically attracted, in order, onto the intermediate transfer belt 15, to form a superposed toner image on the intermediate transfer belt 15.

The secondary transfer part 20 is made up with the secondary transfer roller 22 arranged on the intermediate transfer belt 15 at its toner-image carrying surface and a backup roller 25. The backup roller 25 is arranged on the intermediate transfer belt 15 at its backside, to constitute a counter electrode to the secondary transfer roller 22, and abutted against with a metal-make power-feed roller 26 applied stably with a secondary transfer bias.

Meanwhile, the secondary transfer roller 22 is arranged pressed on the backup roller 25 through the intermediate transfer belt 15. Furthermore, the secondary transfer roller 22 is grounded to form a secondary transfer bias with the backup roller 25 so that a toner image can be secondarily transferred onto the recording sheet P being fed to the secondary transfer part 20.

In the downstream of the secondary transfer part 20 as to the intermediate transfer belt 15, an intermediate transfer belt cleaner 35 is provided for contact therewith so that the intermediate transfer belt 15, after a secondary transfer, can be removed of the remaining toner and paper powder and cleaned at the surface thereof. In the upstream of the yellow image forming unit 1Y, a reference sensor (home-position sensor) 42 is arranged to generate a reference signal giving a reference for the image forming unit 1Y, 1M, 1C, 1K to take the timing of image formation. In the downstream of the black image forming unit 1K, an image concentration sensor 43 is arranged to regulate the image quality. The reference sensor 42 is to generate a reference signal by recognizing a predetermined mark provided on the backside of the intermediate transfer belt 15. Recognizing the reference signal, the control section 40 instructs the image forming units 1Y, 1M, 1C, 1K to start a forming of an image.

The image forming apparatus of this exemplary embodiment has a sheet feed system including a sheet tray 50 containing recording sheets P, a pickup roller 51 that takes up in predetermined timing a recording sheet P stacked in the sheet tray 50 and feeds it, a feed roller 52 that feeds the recording sheet P drawn out by the pickup roller 51, a feed chute 53 that supplies the recording sheet P transported by the feed roller 52 to the secondary transfer part 20, a conveyor belt 55 that delivers, to the fixing device 60, the recording sheet P fed after secondarily transferred at the secondary transfer roller 22, a fixing inlet guide 56 that introduce the recording sheet P to the fixing device 60, and an outlet guide 57 that introduces, to the sheet-feed roller 70, the recording sheet P after fixed at the fixing device 60.

Now explanation is made on the basic process of forming an image on the image forming apparatus to which the present exemplary embodiment is applied.

In the FIG. 1 image forming apparatus, the image data, outputted from a not-shown image reader (IIT), a not-shown personal computer (PC) or the like, is subjected to a predetermined image processing by a not-shown image processing system (IPS), and then produced as an image by means of the image forming units 1Y, 1M, 1C, 1K. The IPS makes a predetermined image processing on the input reflectance data, including shooting correction, positional deviation correction, light-intensity/color-space conversion, gamma correction, frame removal and color editing and various image edits such as movement editing. The image data thus processed is converted into color-material-based grayscale data in four colors, i.e. Y, M, C and K, and outputted to the laser exposure device 13.

The laser exposure device 13 is to illuminate an exposure beam Bm, emitted from a semiconductor laser, onto the photosensitive drum 11 of the image forming unit 1Y, 1M, 1C, 1K, according to the color-material-based grayscale data inputted. In the photosensitive drum 11 of the image forming unit 1Y, 1M, 1C, 1K, the surface thereof is charged by the charger device 12. Then, the surface is scan-exposed by the laser exposure device 13, to form an electrostatic latent image thereon. The formed electrostatic latent image is developed as Y, M, C and K color-based toner images by the developing devices 14 of the image forming units 1Y, 1M, 1C, 1K.

The toner image, formed on the photosensitive drum in the image forming unit 1Y, 1M, 1C, 1K, is transferred onto the intermediate transfer belt 15, in the primarily transfer part 10 where the photosensitive drum 11 is in abutment against the intermediate transfer belt 15. Specifically, at the primary transfer part 10, the primary transfer roller 16 applies a voltage (primary transfer bias), opposite in polarity (plus polarity) to the charge polarity of the toner, to the base material of the intermediate transfer belt 15, thus effecting a primary transfer by superposing toner images, in order, on the surface of the intermediate transfer belt 15.

After primarily transferring the toner images, in order, onto the surface of the intermediate transfer belt, the intermediate transfer belt 15 moves to deliver the toner images to the secondary transfer part 20. When the toner images are delivered to the secondary transfer part 20, the sheet feed system rotates the pickup roller 51 in timing with the transport of the toner images to the secondary transport site 20, to supply a recording sheet P in a predetermined size out of the sheet tray 50. The recording sheet P, supplied by the pickup roller 51, is fed by the transport roller 52 thus reaching the secondary transfer part 20 through the feed chute 53. Before reaching the secondary transfer part 20, the recording sheet P is once stopped. By rotating a register roller (not shown) in movement timing with the intermediate transfer belt 15 carrying thereon toner image, the toner image is put in position with the recording sheet P.

In the secondary transfer part 20, the secondary transfer roller 22 is pushed against the backup roller 25 through the intermediate transfer belt 15. At this time, the recording sheet P, fed in timing, is put to between the intermediate transfer belt 15 and the secondary transfer roller 22. On this occasion, when the power feed roller 26 applies a voltage (secondary transfer bias) same in polarity as the charge polarity of the toner, an electric field is formed at between the secondary transfer roller 22 and the backup roller 25. The unsettled toner image, on the intermediate transfer belt 15, is electrostatically transferred collectively onto the recording sheet, in the secondary transfer part 20 where pressed between the secondary transfer roller 22 and the backup roller 25.

Then, the secondary transfer roller 22 conveys the recording sheet P, the toner images are electrostatically transferred, in a state stripped off the intermediate transfer belt 15, directly onto the conveyor belt 55 provided downstream of the secondary transfer roller 22 with respect to a sheet-feeding direction thereof. The conveyor belt 55 transports the recording sheet P to the fixing device 60, at the optimal rate matched to the feed rate through the fixing device 60. The unsettled toner images, on the recording sheet P delivered to the fixing device 60, is processed for fixing with heat and under pressure, thus being settled on the recording sheet P. The recording sheet P, formed with a fixed image, is conveyed through a sheet feed roller 70 to a sheet tray (not shown) provided at the outlet of the image forming apparatus.

After completing the transfer to the recording sheet P, the remaining toner on the intermediate transfer belt 15 is moved by the circulation of the intermediate transfer belt 15 and removed out of the intermediate transfer belt 15 by means of the cleaning backup roller 34 and the intermediate transfer belt cleaner 35.

(Fixing Device)

The fixing device 60 is now explained.

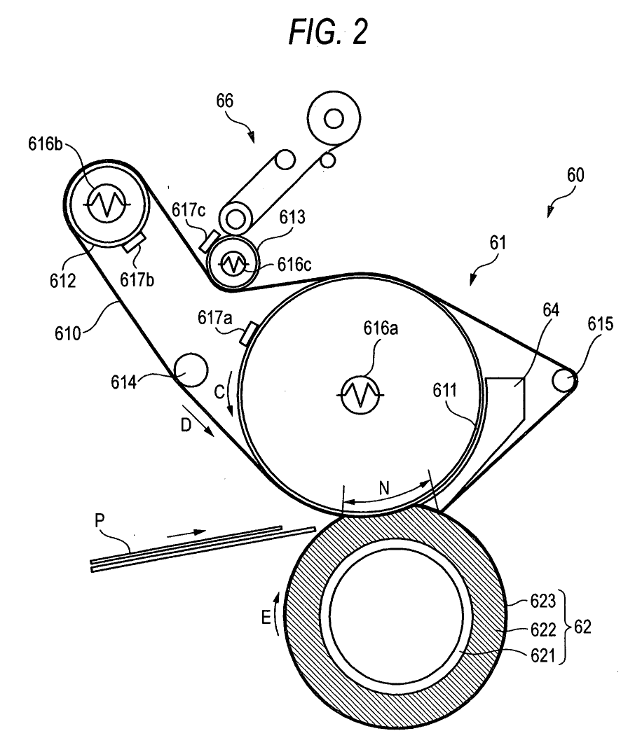

FIG. 2 is a sectional view showing a schematic arrangement of the fixing device 60 in the exemplary embodiment. The fixing device 60 is made up, in its major part, with a fixing belt module 61 serving as a heating member and as a to-be-pressurized member and a pressurizing roller 62, an example of a pressurizing rotary member arranged in contact under pressure with the fixing belt module 61.

The fixing belt module 61 is made up, in its major part, with a fixing belt 610, a fixing roller 611 that is to be driven while giving a tension to the fixing belt 610, a tension roller 612 that gives a tension to the fixing belt 610 from the inner, a position-rectifying roller 614 that rectifies the position of the fixing belt 610 at between the fixing roller 611 and the tension roller 612, and a stripper pad 64 that is an example of a stripper member arranged in a position nearby the fixing roller 611 and downward in the nip site N where the fixing-belt module 61 and the pressurizing roller 62 are in mutual contact under pressure, and a tension roller (idler roller) 615 that gives a tension to the fixing belt 610 in a position downstream of the nip site N. Besides, a cleaning web 66 is provided to clean the surface of the tension roller 613.

The fixing belt 610 is a flexible endless belt having a predetermined circumferential length and width. In the exemplary embodiment, the fixing belt 610 has a three-layer structure having a belt base member of a predetermined material having a thickness of approximately 80 μm, an elastic layer formed by a predetermined elastic member provided over the belt base member and having a thickness of 50 μm or greater and smaller than 200 μm, and a surface release layer formed by a tube of a fluorinated resin provided over the elastic layer.

Here, the belt base member may be, say, of an organic material containing a heat-resistive resin such as polyimide-amide, a metal material such as a stainless steel film, or an inorganic material such as a glass-fiber film.

The elastic member forming the elastic layer may be, say, of a silicone rubber. Meanwhile, the fluorinated resin forming the surface release layer may be, say, of polytetrafluoro-ethylene resin (PTFE), tetrafluoroethylene-perfluoroalkyl vinyl-ether copolymer resin (PFA), ethylene fluoride-propylene copolymer resin (FEP), polyvinylidine resin (PVDF), or polyvinyl fluoride resin.

In the exemplary embodiment, the fluorinated resin tube forming the surface release layer is a non-compressive tube film-formed by extrusion.

In the exemplary embodiment, the fixing belt 610 is formed by adhesion-activating the back surface of a non-compressive fluorinated resin tube film-formed by extrusion and then fit the tube over a surface of the elastic layer, followed by bonding the tube with the elastic layer at a temperature 20° C. lower, preferably 100° C. lower, than a melt point of the fluorinated resin, as mentioned before. In case the bonding temperature is lower, by less than 20° C., than a melt point of the fluorinated resin, there is a tendency to cause recesses or damages in or to the surface of the fixing belt 610 upon fixing on a thick sheet.

In the exemplary embodiment, a liquid silicone rubber (DY35-1213, by Dow Corning Toray) is applied, by flow coat, to a 80-μm thick belt member of polyimide and then heating up it at 120 to 200° C., thereby adhesively solidifying the elastic layer having a thickness smaller than 200 μm.

Then, a primer based on a silane-coupling agent is applied over the elastic layer, by flow coat. Then, the elastic layer is covered at its surface with a tube of tetrafluoroethylene-perfluoroalkyl vinyl-ether copolymer resin (PFA, having a melt point of approximately 300° C.) previously adhesion-activated at its back surface. This is bonded by heating at 150 to 180° C., thereby making a fixing belt 610. Such adhesion activation may be, say, by acid treating, blasting, plasma process or the like without being particularly limited.

Incidentally, the fixing belt 610 can be structured by suitably selecting its material, thickness, hardness, etc. in accordance with the apparatus design conditions of use purpose, use condition and the like.

In the exemplary embodiment, the fixing roller 611 has a predetermined outer diameter, length and thickness, which is a circular cylindrical roller of a metal, such as steel or aluminum. The fixing roller 611 has no elastic layer in the surface thereof. By the absence of an elastic layer in the surface of the fixing roller 611, the fixing belt 610 is reduced of the damage to the surface thereof resulting from sheet pass, as referred later. The fixing roller 611 is to rotate usually at a surface velocity of approximately 300 mm/s in a direction of arrow C, on a drive force of from a not-shown drive motor.

Meanwhile, the fixing roller 611 is arranged therein with a halogen heater 616a having a rating, say, of 900 W, as a heating source. Based on a measurement value of a temperature sensor 617a arranged in contact with a surface of the fixing roller 611, the control section 40 (see FIG. 1) of the image forming apparatus controls the surface temperature of the fixing roller 611 usually at approximately 150° C.

The tension roller 612 is formed in a circular cylindrical form of aluminum having a predetermined outer diameter, wall thickness and length. The tension roller is arranged therein with a halogen heater 616b having a rating, say, of 1000 W, as a heating source. By means of the temperature sensor 617b and control section 40 (see FIG. 1), the tension roller 612 is controlled in its surface temperature at 190° C. The tension roller 612 serves to give a tension to the fixing belt 610 and also to heat up the fixing belt 610.

Meanwhile, spring members (not shown) are arranged at both ends of the tension roller 612, to pull the fixing belt 610 outward. The tension belt 610 is set up wholly with a tension usually at approximately 15 kgf. In order to make the tension acting upon the fixing belt 610 uniform in the widthwise and reduce the axial displacement of the fixing belt 610 to a possible minimal extent, the tension roller 612 is formed so-called in a crown form made greater in the outer diameter by approximately 100 μm in the center than at the both ends thereof.

The tension roller 613 is in a circular cylindrical form of aluminum having a predetermined outer diameter, wall thickness and length. In the surface of the tension roller 613, a release layer is formed by being covered with PFA in a thickness usually of 20 μm. The release layer is formed to prevent an offset toner or paper powder from depositing slight in amount on the tension belt 610, from the outer peripheral surface of the fixing belt 610. The tension roller 613 is also formed in a crown form made greater in outer diameter by approximately 100 μm in the center than at the both ends thereof. Incidentally, any one of the tension rollers 612, 613 may be formed in a crown form without limited to forming both the tension rollers 612, 613 in a crown form.

The tension roller 613 is arranged therein with a halogen heater 616c having a rating, say, of approximately 1000 W, as a heating source so that the surface temperature can be controlled at around 190° C. by the temperature sensor 617c and control section 40 (see FIG. 1). Consequently, the tension roller 613 serves not only to give a tension to the fixing belt 610 and also to heat up the fixing belt 610 at the outer surface thereof. Accordingly, the exemplary embodiment employs a structure to heat up the fixing belt 610 by means of the fixing roller 611 and tension rollers 612, 613.

The position-rectifying roller 614 is formed in a circular cylindrical form of aluminum having a predetermined outer diameter and length. In the substantial vicinity of the position-rectifying roller 614, a belt-edge position detecting mechanism (not shown) is arranged to detect an edge position of the fixing belt 610. The position-rectifying roller 614 is arranged with an axial displacing mechanism that is to axially displace the abutment position of the fixing belt 610, in accordance with the result of detection by the belt-edge position detecting mechanism. Thus, the fixing belt 610 is controlled against erratic movement (belt walk).

In the fixing device 60 which the exemplary embodiment is applied, a stripper pad 64 is provided as an example of a stripper member that is a block member nearly in an arcuate form in section of a rigid material, such as a SUS metal or a resin. The stripper pad 64 is arranged fixed axially entirely of the fixing roller 611, in a position downward the region the pressurizing roller 62 is contacted under pressure with the fixing roller 611 through the fixing belt 610. Meanwhile, the stripper pad 64 is arranged to uniformly press the pressurizing roller 62 at its predetermined region (e.g. over a width 2 mm along the movement direction of the fixing belt 610) through the fixing belt 610, at a predetermined load (e.g. 10 kgf in average).

Meanwhile, the tension roller 615 is formed in a circular cylindrical form of aluminum having a predetermined outer diameter and length. The tension roller 615 is arranged in a position downward of the stripper pad 64 with respect to the movement of the fixing belt 610 in order to smoothly circulate the portion of the fixing belt 610, passed the stripper pad 64, toward the fixing roller 611.

In the exemplary embodiment, the pressurizing roller 62, as a pressurizing member, has, as a basic member, a cylindrical roller 621 of a metal, such as steel or aluminum. The pressurizing roller 62 is structured as a soft roller by laying an elastic layer 622 of an elastic member such as of silicone rubber and a release layer 623 of a fluorinated resin, in the order of from the basic member. In the exemplary embodiment, the elastic layer 622 has a thickness of approximately 10 mm. The release layer has a thickness of approximately 100 μm.

In this manner, in the exemplary embodiment, by providing the elastic layer 622 for the pressurizing roller 62, the fixing belt 610 is reduced of the damage to the surface thereof due to sheet pass, as referred later.

As shown in FIG. 2, the pressurizing roller 62 is arranged in a manner pressed onto the fixing belt module 61. By the rotation of the fixing roller 611 of the fixing belt module 61 in a direction of arrow C, the pressurizing roller 62 is rotated in a direction of arrow E following the fixing roller 611.

In the fixing device 60 of the exemplary embodiment, the pressurizing roller 62 is nipped with the fixing roller 611 by a predetermined nip mechanism (not shown) through the fixing belt 610. Meanwhile, the fixing belt 610 is circulated in a direction of arrow D by a predetermined drive mechanism (not shown), by which the pressurizing roller 62 is rotated in a direction of arrow E.

The sheet P, an unfixed toner is carried, is inserted in the fixing device 60 where it is fixed with heating at a nip site N formed by the fixing belt 610 and the pressurizing roller 62, followed by being stripped by the stripper pad 64. The sheet P is conveyed to a paper tray (not shown) provided at an outlet of the image forming apparatus through a sheet feed roller 70 (see FIG. 1).

In the fixing device 60 of this exemplary embodiment, a nip load is assumed established to provide a maximum on-surface pressure of 1 MPa (10 kgf/cm²) when passing a sheet through the nip site N of between the fixing roller 611 and pressurizing roller 62, at a process rate of 300 mm/s and a nip width of 15 mm, for example.

Meanwhile, by providing the stripper pad 64 as a stripper member arranged to press the fixing belt 610 at its outer surface on the pressurizing roller 62 in a position downward of the nip site N, blister is reduced from occurring resulting from the water vapor produced from a sheet P or toner upon fixing. Furthermore, a dense image is to be stripped without giving damage to a sheet P. Meanwhile, such damages or recesses as caused upon fixing on a thick sheet, can be reduced in the fixing belt 610 at its surface release layer made by a fluorinated-resin tube in a surface thereof.

(Toner)

The color toner, in a color component to be developed by the development device 14 (see FIG. 1) of the image forming unit 1Y, 1M, 1C, 1K in the exemplary embodiment, contains a suitable additive for the purpose, e.g. a solidified resin such as a polyester resin, a coloring agent such as a dye or a sublimation dye, a release agent such as a wax, charge control material or the like. Particularly, the toner used in the exemplary embodiment contains a release agent (contained or added), to act as an oil strainer capable of obtaining the releasability between the recording sheet P the toner image is fixed and the fixation member without the provision of a release-material applicator device.

The method of producing such a toner is not especially limited but may be a knead-and-crush process that a solidified resin, a coloring agent and an additive are knead together and then crushed, a suspension polymerization process that a coloring agent, a release agent, etc. are suspended together with a polymeric monomer into polymerization with the polymeric monomer, a dissolving-and-suspension process that toner materials of a solidified resin, a coloring agent, a release agent, etc. are dissolved in an organic solvent and dispersed in a suspension state in a water-based solvent and then removed of the organic solvent, an emulsified polymerization aggregation amalgamation process that a resin is prepared by emulsified polymerization and hetero-aggregated together with a dispersion liquid of pigments, release agent etc. and the amalgamated.

(Release Agent)

The toner, used in the exemplary embodiment, contains a release agent such as a wax. Generally, by containing a release agent in the toner, a broader fixing latitude is to be obtained even where not using a release oil on the surface of the fixing belt 610 formed in the fixing device 60. Here, fixing latitude refers to a temperature range of between a lower temperature (lowest fixing temperature) at which an unfixed toner image is to fix on a recording sheet P and a higher temperature (offset occurring temperature) at which the toner image becomes not released from the fixing belt when the temperature of the fixing belt 610 is changed.

The addition amount of the release agent, usually, is suitably 0.5 to 50 percent by weight relative to the toner, preferably 1 to 30 percent by weight, more preferably 5 to 15 percent by weight. Within the above range, release-agent addition effect is obtainable. Meanwhile, fluidity and charge characteristic improves because the exposure degree at the toner surface is provided proper.

Such a release agent may be, say, waxes, for example, a crystalline wax. Specifically, the crystalline wax may be a low-molecular polyolefin wax, such as of polyethylene, polypropylene or polybutene. Waxes may be a vegetable wax, such as carnauba wax, cotton wax, wooden wax or rice wax; animal wax such as yellow beeswax or lanoline; mineral wax such as ozokerite or selsyn; petroleum wax such as paraffin, microcrystalline or petrolatum.

Besides natural waxes, it is possible to use also a synthetic carbon-hydride wax of Fischer-Tropsch wax or polyethylene wax, or a synthetic wax of 12-hydroxy amido stearate, amido stearate, phthalic anhydride imide, fatty acid amido such as chlorinated hydrocarbon, ester, ketone and ether.

Furthermore, it is possible to use polyacrylate polymer such as poly n-stearyl methacrylate, poly n-lauryl methacrylate.

Of the release agents, a crystalline wax is preferred. The crystalline wax has a melt point of usually 40 to 150° C., preferably 50 to 120° C. By using a crystalline wax having a melt point somewhat lower than the melt point of a solidified resin in the toner, the crystalline wax effectively fuses earlier than the solidified resin. This improves the release characteristic, upon stripping, at the outlet of the nip site N of the fixing device 60.

Incidentally, the solidified resin in the toner is not especially limited but can use a material for general use as a solidified resin for a toner. Such a solidified resin may be a polyester resin, a styrene resin, an acrylic resin, a styrene-acrylic resin, a silicone resin, an epoxy resin, a diene resin, a phenol resin, ethylene-vinyl acetate resin or the like.

Now explanation is made on the occurrence of recesses or damages in or to the surface of the fixing belt 610 during the fixing process.

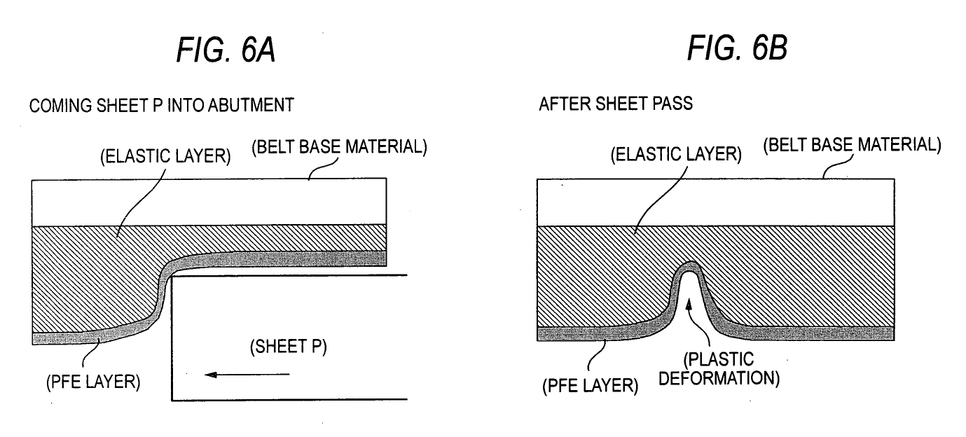

FIGS. 6A and 6B is a schematic sectional view explaining a deformation in the surface of the fixing belt 610, wherein FIG. 6A is in the state the sheet P comes into abutment while FIG. 6B is in the state the sheet has passed.

In the surface of the fixing belt 610 structured with three layers, i.e. a belt base member, an elastic layer and a PFA layer (surface release layer), the PFA layer is deformed together with the elastic layer by the insertion of a sheet P, as shown in FIG. 6A. Here, because the fluorinated resin layer such as of PFA is deficient in elasticity and hence easy to plastically deform as compared to the elastic member forming the elastic layer as mentioned before, a plastic deformation remains even after the passage of the sheet P as shown in FIG. 6B. This results in the occurrence of recesses or damages in or to the surface of the fixing belt 610.

With the fixing device 60 to which the exemplary embodiment is applied, the fixing belt 610 is reduced of recesses or damages from occurring in the surface thereof thus preventing the occurrence of a linear defect in the image.

Namely, in the exemplary embodiment, when forming a surface release layer for a fixing belt 610 serving as a fixing member, adhesion-activating treatment is previously done on a backside of the PFA tube film-formed by an extrusion process, to bond the tube over the elastic layer provided on the belt basic member for a fixing belt 610 at a temperature (150 to 180° C.) fully lower than the PFA melt point of approximately 300° C. When fixing on a thick sheet, a quality fixed image can be obtained free of recesses or damages in or to the PFA surface.

Here, the method of forming a surface layer for a fixing member by use of a fluorinated resin, such as PFA, may be, say, a process of spray-coating an elastic-PFA-based aqueous dispersion (coat), a process of heating a heat-contractive PFA tube film-formed by extrusion up to a PFA melt point and thermally bond it with the elastic layer (heat fusion tube), or a process of adhesion activating the backside of a non-contractive PFA tube film-formed by extrusion and fitting it over a primer-applied elastic layer followed by bonding those at a temperature fully lower than the PFA melt point (post-cover tube).

Of the methods to form a surface layer using a fluorinated resin, the surface layer (coat) formed by spray-coating a PFA aqueous dispersion is inferior in wear resistance because of its lower molecular weight, and inferior in mechanical characteristic because of its coat film nature.

Meanwhile, higher molecular weight is obtainable in the surface layer (heat fusion tube) formed by thermally bonding the heat-contractive PFA tube at a temperature around the PFA melt point. Meanwhile, although film strength increases rather than the coat film, crystal orientation is lost by re-melting upon thermal fusion thus lowering the mechanical characteristics upon forming the tube.

On the contrary, the fixing belt 610 in the exemplary embodiment is to obtain a sufficient film strength and mechanical characteristic without losing PFA crystal orientation, by forming a surface release layer with using a PFA post-cover tube.

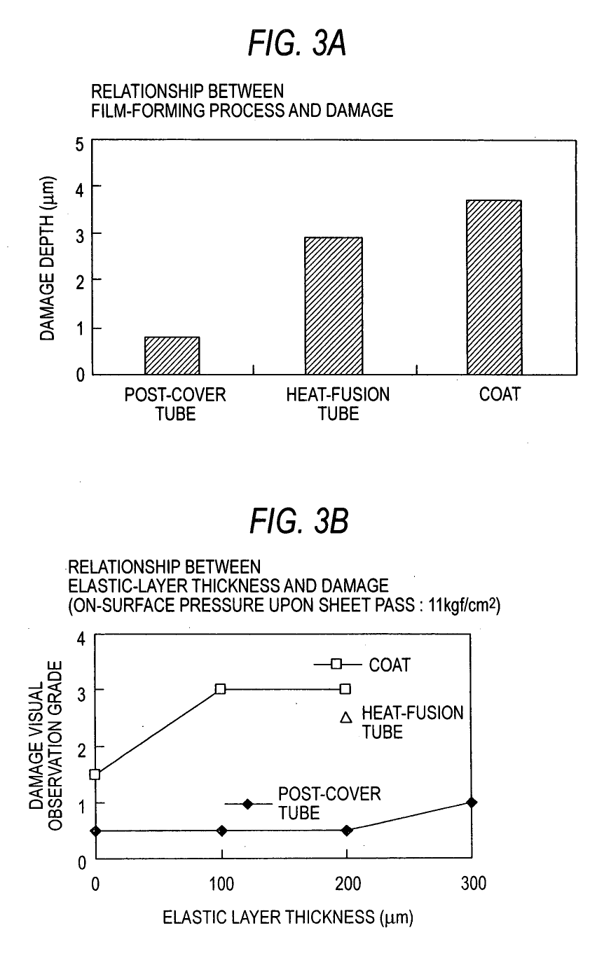

FIGS. 3A and 3B are figures explaining a relationship between a film-forming process for a fixing belt 610 and a resulting damage, and a relationship between an elastic layer thickness of a fixing belt 610 and a resulting damage.

FIG. 3A shows a result of measurement, made by using a predetermined fixing evaluating device, on a depth of a damage caused in the surface release layer due to the difference in film-forming process. As shown in FIG. 3A, it can be seen that the damage depth (μm) in the surface release layer of the fixing belt 610 decreases in the order of coat, heat fusion tube and post-cover tube.

Here, as for the damage depth in the surface release layer, evaluation was made on the damage depth in a fixing belt, i.e. a test piece, by passing a Starwhite Tiarra Cover LG as an A4 LEF at a process rate of 157 mm/s on the fixing evaluation device.

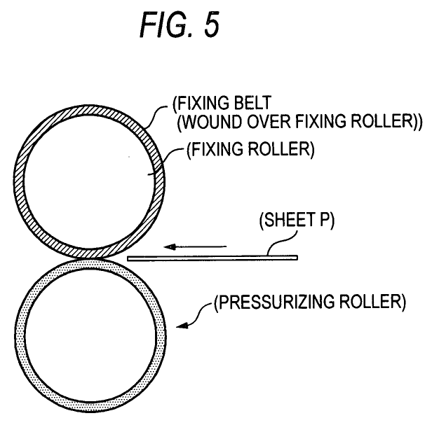

FIG. 5 is a figure explaining the fixing evaluation device. The fixing evaluation device shown in FIG. 5 is a device that the nip site N of the fixing device 60 of the exemplary embodiment is simplified for evaluating a test-piece fixing belt. In FIG. 5, the fixing roller is of φ50 mm and made of aluminum. The test-piece fixing belt is directly wound over the fixing roller. The pressurizing roller, of φ50 mm, has an elastic layer of silicone rubber having a thickness of 2 mm and a hardness of 35 Hs, and a surface layer formed by a PFA tube provided over the elastic layer. The fixing nip is set with a nip load such that the maximum on-surface pressure is given 1.1 MPa (11 kgf/cm²) at a nip width of 5 mm upon sheet pass.

In the exemplary embodiment, by providing the fixing belt 610 with an elastic layer at smaller than 200 μm, both are achieved of the reduction of damages and the improvement of fixed image quality.

FIG. 3B shows a relationship between an elastic layer thickness and a damage caused in the belt surface. Here, the damage caused in the test-piece fixing belt was evaluated by passing a Starwhite Tiarra Cover LG as an A4 LEF at a process rate of 157 mm/s on the fixing evaluation device shown in FIG. 5, based on the following criterion (damage visual observation grade).

0: no damages confirmed by visual observation

1: obscure trace observed in a linear form

2: weak line observed

3: obvious line observed

Incidentally, according to the result of an experiment conducted by the present inventor, the damage caused in the belt surface was revealed recognizable more clearly in the form of an image as image gloss increases. For example, in the case 60-degree image gloss is 60 or higher, the damage caused in the belt surface is to be recognized as an image at a damage visual observation grade of greater than 2.

From the result shown in FIG. 3B, it may be seen that, concerning the damage in the test-piece fixing belt, damage visual observation grade increases and damage worsens as the thickness of the elastic layer increases. Particularly, it may be seen that damage visual observation grade greatly rises as to the surface layer (coat) formed by spray-coating a PFA based aqueous dispersion and the surface layer (heat fusion tube) formed by thermally bonding a heat-contractive PFA tube at around the PFA melt point.

On the contrary, it may be understood that, where the surface release layer is formed by using a post-cover tube of PFA, damage visual observation grade may be maintained at 1 or smaller. Particularly, the elastic layer thickness may be known preferably smaller than about 200 μm.

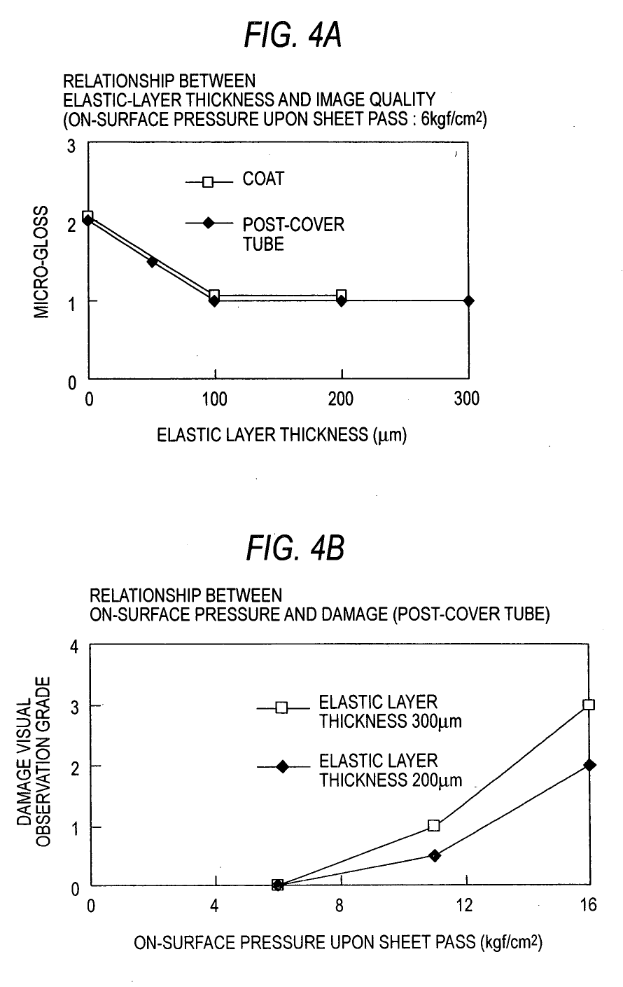

FIGS. 4A and 4B are figures explaining a relationship between an elastic layer thickness for a fixing belt 610 and an image quality and a relationship between an on-surface pressure and a damage (image quality).

In FIG. 4A, there is shown a relationship between an elastic layer thickness and a micro-gloss on an obtained image. As shown in FIG. 4A, at an elastic layer thickness of 50 μm or greater, micro-gloss reduces. As it becomes greater, micro-gloss reduces. It may be seen that, at about 100 μm and over, micro-gloss saturates in a level confirmed slight. As a result, it may be understood that the fixing belt 610 desirably has an elastic layer thickness of about 50 μm or greater.

Here, micro-gloss is those evaluated by passing a J-sheet, by Fuji Xerox Office Supply, with an unfixed toner image in CMYK four colors with Cin 100% at a process rate of 157 mm/s on the FIG. 5 fixing evaluation device having a fixing roller at 140° C. and a pressurizing roller at 120° C. Meanwhile, on-surface pressure is 6 kgf/cm² during sheet pass.

Incidentally, micro-gloss represents a surface concavo-convex encountered when the toner is insufficiently smoothened at within the fixing nip site, which evaluated based on the following criterion.

0: on-surface concavo-convex not confirmed by visual observation

1: on-surface concavo-convex confirmed slight by visual observation

2: on-surface concavo-convex confirmed somewhat by visual observation

3: on-surface concavo-convex confirmed obvious by visual observation

Meanwhile, in the exemplary embodiment, by providing the fixing roller 611 with no elastic layer in the surface thereof and the pressurizing roller 62 with an elastic layer in the surface thereof, damages may be reduced on the fixing belt 610.

FIG. 4B shows a relationship between an on-surface pressure upon sheet pass and a damage evaluated on a test-piece fixing belt whose surface release layer is formed by using a PFA post-cover tube, on the FIG. 5 fixing evaluation device. Incidentally, Starwhite Tiara Cover LG is used as a sheet to pass.

From FIG. 4B, it may be seen that damage visual observation grade worsens with the increase of elastic layer thickness and on-surface pressure upon sheet pass. This may be considered because of the reason that the PFA surface release layer becomes easier to deform due to the significant deformation of the elastic layer of the test-piece fixing belt.

Concerning this, similar effect is to be considered where an elastic layer is present in the surface of the fixing roller 611 in the exemplary embodiment. Namely, it may be seen that the fixing roller 611, if provided with an elastic layer, makes it structurally easy to cause damages to the fixing belt 610.

Meanwhile, from FIG. 4B, it may be seen that, where the fixing belt 610 has an elastic layer having a thickness of smaller than about 200 μm in the exemplary embodiment, the damage caused in the surface of the fixing belt 610 may be given 2 or smaller in terms of damage visual observation grade even at an on-surface pressure of about 1.6 MPa (16 kgf/cm²) upon sheet pass.

From the result, by providing the fixing belt 610 with an elastic layer thickness of smaller than about 200 μm and an on-surface pressure upon sheet pass of about 1.6 MPa (16 kgf/cm²) or smaller, damages may be reduced in the surface of the fixing belt 610 even in case sheets are fed duplicated or a thick sheet is passed.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The exemplary embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A fixing device comprising:
a fixing belt that has a surface release layer of a fluorinated-resin tube, the fixing belt being laid across by a fixing roller and a tension roller;
a pressurizing member that presses the fixing roller through the fixing belt; and
a release member that presses the fixing belt on the pressurizing member, in a substantial vicinity of a downstream of a pressure contact site of between the fixing roller and the pressurizing member, and strips a recording material from the fixing belt,
the fixing device fixing a toner image on the recording material by heat.

2. A fixing device according to claim 1,
wherein the fixing belt has a three-layer structure having (i) a belt base member, (ii) an elastic layer of an elastic member on the belt base member and having a thickness equal to or greater than about 50 μm and smaller than about 200 μm, and (iii) the surface release layer on the elastic layer.

3. A fixing device according to claim 2,
wherein the fixing belt is formed by adhesion-activating a back surface of the tube, fitting the tube over the elastic layer and bonding the elastic layer with the tube at a temperature lower about 20° C. or more than a melt point of the fluorinated resin.

4. A fixing device according to claim 1,
wherein the fixing roller does not comprise an elastic layer of an elastic member on a surface of the fixing roller, and the pressurizing roller comprises an elastic layer of an elastic member on a surface of the pressurizing roller.

5. A fixing device according to claim 1,
wherein a nip mean pressure is about 16 kgf/cm² or less in the pressure contact site.

6. A fixing device that fixes an toner image on a recording material, the fixing device comprising:
a fixing member including an elastic layer of an elastic member and a surface release layer of a fluorinated-resin tube on the elastic layer; and
a pressurizing rotary member provided in pressure contact with the fixing member, to form a nip site where to pass the recording material,
the surface release layer being formed by bonding the elastic layer with the tube at a temperature lower at least about 20° C. than a melt point of the fluorinated resin.

7. A fixing device according to claim 6,
wherein the fluorinated-resin tube is film-formed by extrusion.

8. A fixing device according to claim 6,
wherein the toner image is formed by using a toner comprising a release agent.

9. An image forming apparatus comprising a fixing device, the fixing device comprising:
a fixing belt including an elastic layer of an elastic member and a surface release layer of a fluorinated-resin tube on the elastic layer, the fixing belt being laid across by a fixing roller and a tension roller;
a pressurizing roller that presses the fixing roller through the fixing belt and forms a nip site where to pass a recording material; and
a stripper member that presses the fixing belt on the pressurizing member in a substantial vicinity of a downstream of the nip site and strips the recording material from the fixing belt,
the image forming apparatus forming an image on the recording material by use of a toner containing a release agent, and
the fixing device fixing a toner image on the recording material by heat.
